(19) United States
(12) Patent Application Publication
(10) Pub. No.: US 2013/0165039 A1
(43) Pub. Date: Jun. 27, 2013

(54) ELECTRIC LAMP HOLDER MODULE WITH A BUILT-IN SIGNAL REPEATER

(71) Applicant: Nai-Chien CHANG, New Taipei City (TW)

(72) Inventor: Nai-Chien CHANG, New Taipei City (TW)

(21) Appl. No.: 13/678,174

(22) Filed: Nov. 15, 2012

(30) Foreign Application Priority Data
Dec. 23, 2011 (TW) 100224401

(51) Int. Cl. H04W 88/04

(52) U.S. Cl. CPC H04W 88/04
USPC 455/7

(57) ABSTRACT

An electric lamp holder module includes an electric lamp holder, an operational amplifier, a signal receiving unit, and an output antenna. The electric lamp holder module is embedded in a pre-arranged electric lamp slot through the electric lamp holder and receives an electric power supplied from a wall socket power through the electric lamp slot. The signal receiving unit receives an external transmission signal. The output antenna is configured to send out the transmission signal after the transmission signal has been amplified by the operational amplifier. Therefore, the electric lamp holder module is used as a signal repeater. The transmission signal is amplified by the operational amplifier for prolonging the transmission distance.

This application is based on and claims the benefit of Taiwan Application No. 100224401 filed Dec. 23, 2011 the entire disclosure of which is incorporated by reference herein.

### BACKGROUND OF THE INVENTION

1. Field of the Invention

The present invention relates to an electric lamp holder module, and especially relates to an electric lamp holder module with a built-in signal repeater.

2. Description of the Related Art

More and more electronic devices (for examples, computers, Tablet PCs, smart phones, and PDAs etc.) are available now because the semiconductor technology is progressing every day. The users use the electronic devices which have powerful functions every day for work or entertainment.

The network connection is one of the most important functions for the electronic devices. Therefore, it is important to successfully connect to the Internet for the electronic devices. FIG. 1 shows an application diagram of the related art arrangement. Generally speaking, a modem 3 is connected to an internet service provider (ISP, not shown in FIG. 1) for the users to surf the Internet.

The user may use an electronic device 5 which is connected to the modem 3 with a network line to surf the Internet. Moreover, the modem 3 is connected to a wireless access point 4. The user may use an electronic device 6 which is wirelessly connected to the wireless access point 4 for surfing the Internet.

To reduce the obstacles on the paths for wireless signal transmission is important. The received wireless signal is stronger if the obstacles on the paths for wireless signal transmission are less. Therefore, the wireless signal received by the electronic device 6 may be not stable or may be too weak to recognize if there are too many obstacles between the electronic device 6 and the wireless access point 4.

Generally speaking, a ceiling has fewer obstacles in a building. Plural electric lamp slots 1 are usually pre-arranged on the ceiling. The electric lamp slot 1 is electrically connected to the wall socket power through a switch 10. An electric lamp 2 is embedded in the electric lamp slot 1. The electric lamp 2 is electrically connected to the wall socket power through the electric lamp slot 1. The electric lamp 2 receives electric power supplied from the wall socket power 100 if the switch 10 is turned on. Then the electric lamp 2 is lighting. On the contrary, the electric lamp 2 is not lighting if the switch 10 is turned off.

Therefore, the present invention is to provide a signal repeater arranged on the ceiling. Moreover, the present invention is to provide the signal repeater integrated with the electric lamp slot 1.

### SUMMARY OF THE INVENTION

In order to solve the above-mentioned problems, an object of the present invention is to provide an electric lamp holder module with a built-in signal repeater. An operational amplifier of the signal repeater is configured to amplify the wireless signal strength, so that the transmission distance is longer.

In order to achieve the object of the present invention mentioned above, the electric lamp holder module includes an electric lamp holder, an operational amplifier, a signal receiving unit, and an output antenna. The electric lamp holder module is embedded in a pre-arranged electric lamp slot through the electric lamp holder and receives an electric power supplied from a wall socket power through the electric lamp slot. The signal receiving unit receives an external transmission signal. The operational amplifier is configured to amplify the transmission signal. The output antenna is configured to send out the transmission signal after the transmission signal has been amplified by the operational amplifier.

The efficiency of the present invention is to embed the electric lamp holder module in the pre-arranged electric lamp slot in the indoor. The transmission signal is amplified by the electric lamp holder module. Therefore, the transmission signal is still strong even if there are many obstacles in the indoor. Moreover, a plurality of the electric lamp holder modules are embedded respectively in a plurality of the electric lamp slots which are arranged in different places (for examples, the living room, the bedroom, the restaurant, or the balcony). Therefore, the transmission distance is longer because the transmission signal is transmitted through the electric lamp holder modules.

### BRIEF DESCRIPTION OF DRAWING

FIG. 1 shows an application diagram of the related art arrangement.

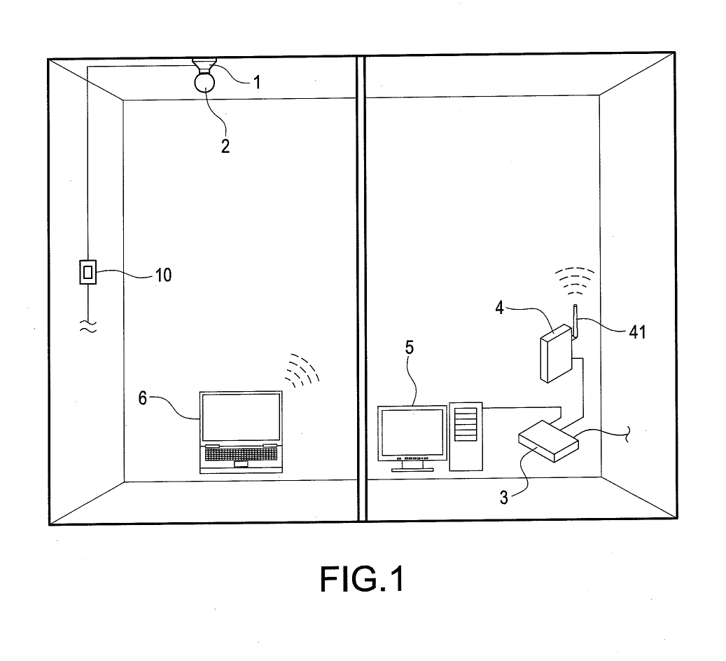

FIG. 2 shows an application diagram of the present invention.

FIG. 3A shows a diagram of an embodiment of the electric lamp holder module before being embedded in the electric lamp slot.

FIG. 3B shows a diagram of an embodiment of the electric lamp holder module after being embedded in the electric lamp slot.

FIG. 4 shows a block diagram of an embodiment of the electric lamp holder module of the present invention.

FIG. 5 shows a diagram of another embodiment of the electric lamp holder module after being embedded in the electric lamp slot.

FIG. 6 shows a diagram of another embodiment of the electric lamp holder module after being embedded in the electric lamp slot.

FIG. 7 shows a block diagram of another embodiment of the electric lamp holder module of the present invention.

### DETAILED DESCRIPTION OF THE INVENTION

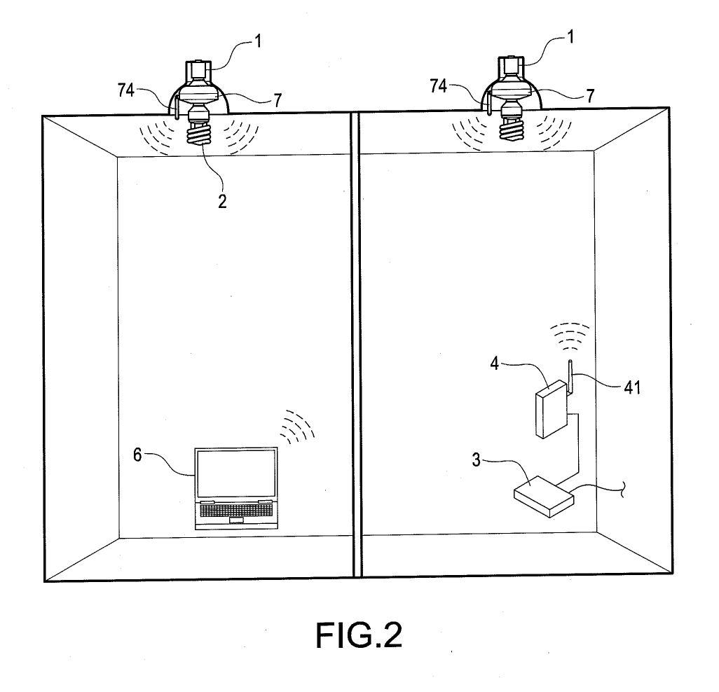

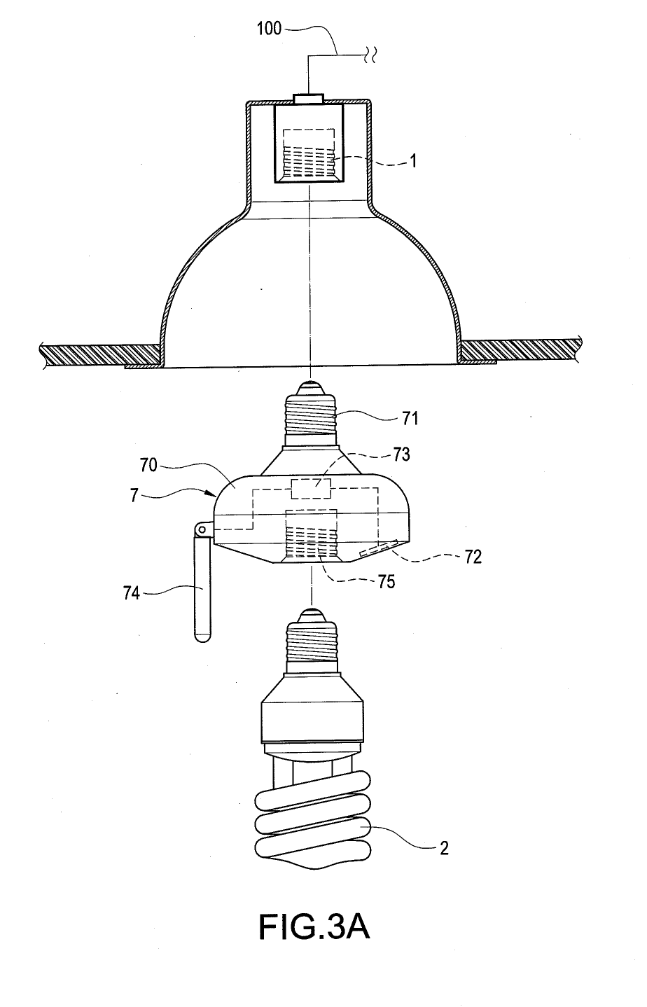

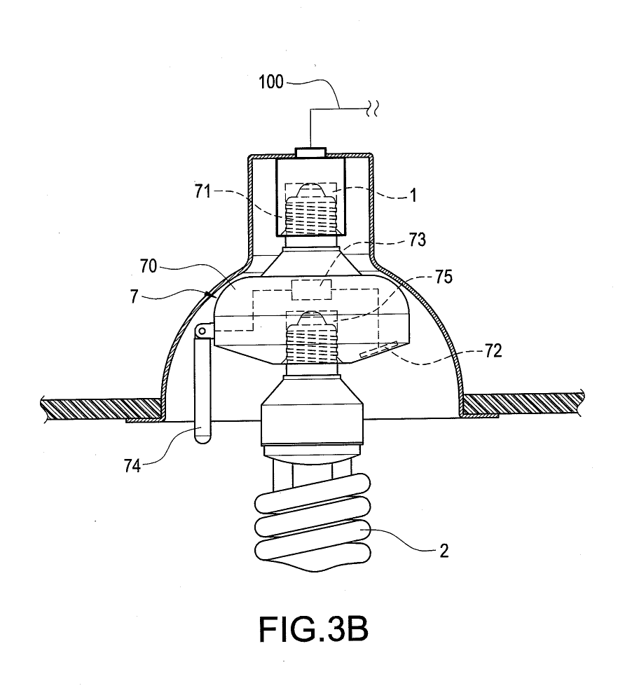

FIG. 2 shows an application diagram of the present invention. The present invention is to provide an electric lamp holder module 7 with a built-in signal repeater. The electric lamp holder module 7 is embedded in a pre-arranged electric lamp slot 1. Therefore, the electric lamp holder module 7 receives an electric power supplied from a wall socket power 100 (as shown in FIG. 3A) through the electric lamp slot 1. Therefore, the electric lamp holder module 7 does not require an extra power supply unit.

A modem 3 is connected to an ISP. The modem 3 is electrically connected to a wireless access point 4. Therefore, the user can use an electronic device 6 (for examples, a notebook or a Tablet PC) to surf the Internet through an antenna 41 of the wireless access point 4. Moreover, a plurality of the electric lamp holder modules 7 are embedded respectively in a plurality of the electric lamp slots 1 which are arranged in different places. Therefore, each of the electric lamp holder modules 7 receives network signals sent from the wireless access point 4 or sent from the other electric lamp holder modules 7. The network signals are sent out again after the network signals are received by the electric lamp holder modules 7 and are amplified by the signal repeater built in the electric lamp holder module 7. Because the network signals are amplified again and again, the network signals are always strong enough for being received by the electronic device 6 even if the distance between the electronic device 6 and the wireless access point 4 is long. Moreover, the pre-arranged electric lamp slots 1 are usually arranged on the ceilings which have the fewer obstacles in a building, so sending the network signals between the electric lamp holder modules 7 is the best.

FIG. 3A shows a diagram of an embodiment of the electric lamp holder module before being embedded in the electric lamp slot. FIG. 3B shows a diagram of an embodiment of the electric lamp holder module after being embedded in the electric lamp slot. Generally speaking, a connection circuit (for example, a connection circuit for connecting to the wall socket power 100) is preserved for the lamp on the ceiling. The electric lamp slot 1 is connected to the connection circuit. Therefore, the electric lamp 2 would be embedded in the electric lamp slot 1 for using. The present invention is to provide the electric lamp holder module 7. The electric lamp holder module 7 receives the electric power supplied from the wall socket power 100 through the electric lamp slot 1. The electric lamp 2 is embedded in the electric lamp holder module 7. The electric lamp 2 receives the electric power through the electric lamp holder module 7 and is lighting.

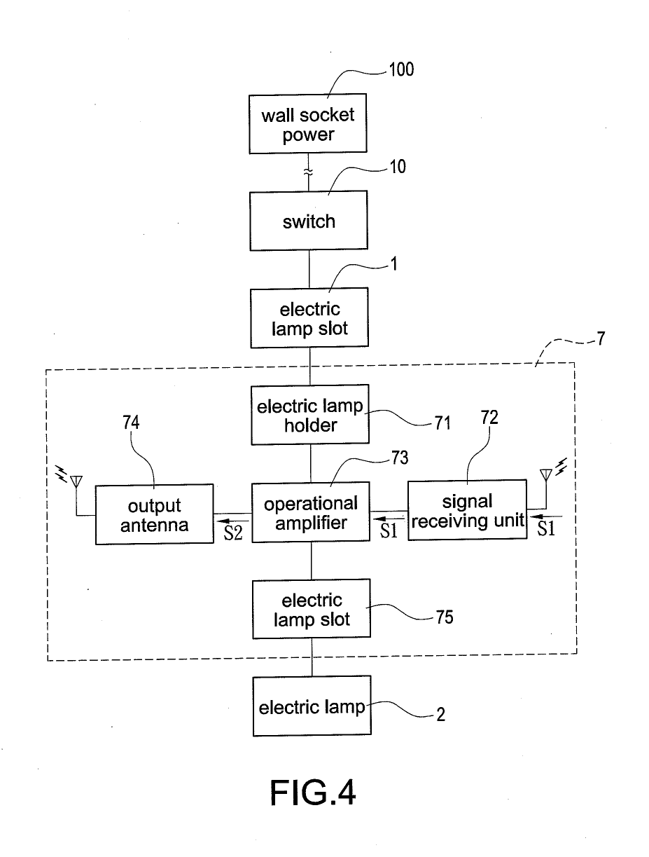

The electric lamp holder module 7 receives an external transmission signal Si (as shown in FIG. 4). The electric lamp holder module 7 is configured to amplify the transmission signal S1 as a transmission signal S2 (as shown in FIG. 4). The electric lamp holder module 7 is configured to send out the transmission signal S2. Therefore, the electric lamp holder module 7 is used as a signal repeater for amplifying the transmission signal S1 and prolonging the transmission distance.

FIG. 4 shows a block diagram of an embodiment of the electric lamp holder module of the present invention. The electric lamp holder module 7 includes an electric lamp holder 71, a signal receiving unit 72, an operational amplifier 73, an output antenna 74, and an electric lamp socket 75. The electric lamp holder module 7 is embedded in the electric lamp slot 1 through the electric lamp holder 71. The electric lamp slot 1 is electrically connected to the wall socket power 100 through a switch 10. The electric lamp holder module 7 receives the electric power supplied from the wall socket power 100 if the switch 10 is turned on. On the contrary, the electric lamp holder module 7 is not working if the switch 10 is turned off.

The electric lamp holder module 7 further includes a housing 70 (as shown in FIGS. 3A and 3B) covering the electric lamp holder 71, the operational amplifier 73, the signal receiving unit 72, and the electric lamp socket 75. The output antenna 74 is arranged outside the housing 70 for receiving stronger signal. Moreover, the output antenna 74 is, for example but not limited to, a directional antenna.

The operational amplifier 73 is electrically connected to the electric lamp holder 71 and receives the electric power through the electric lamp holder 71. The operational amplifier 73 is electrically connected to the signal receiving unit 72 and the output antenna 74. A signal repeater includes the signal receiving unit 72, the operational amplifier 73, and the output antenna 74. The signal receiving unit 72 receives the external transmission signal S1. The signal receiving unit 72 is configured to send the transmission signal Si to the operational amplifier 73. The operational amplifier 73 is configured to amplify the transmission signal S1 as the transmission signal S2. The operational amplifier 73 is configured to send the transmission signal S2 to the output antenna 74. The output antenna 74 is configured to send out the transmission signal S2. Therefore, the transmission signal S2 is received and recognized by the electronic device 6 without weak or unstable signal problems which are raised because there are too many obstacles or the transmission distance is too long.

The electric lamp socket 75 is electrically connected to the operational amplifier 73 and receives the electric power supplied from the wall socket power 100 through the operational amplifier 73 and the electric lamp holder 71. Moreover, the electric lamp socket 75 could be electrically connected to the electric lamp holder 71 directly as well. The electric lamp 2 is embedded in the electric lamp socket 75 and receives the electric power through the electric lamp holder module 7.

The signal receiving unit 72 is, for example but not limited to, an antenna unit (for example, a chip antenna or a directional antenna) as shown in FIG. 3A and 3B. The transmission signal S1 is a wireless fidelity (Wi-Fi) signal or a Bluetooth transmission signal. The signal receiving unit 72 wirelessly receives the external transmission signal S1. The transmission signal S1 is, for example, a wireless fidelity (Wi-Fi) signal sent from the wireless access point 4 or a Bluetooth transmission signal sent from other electronic device (not shown in FIGS. 3A and 3B).

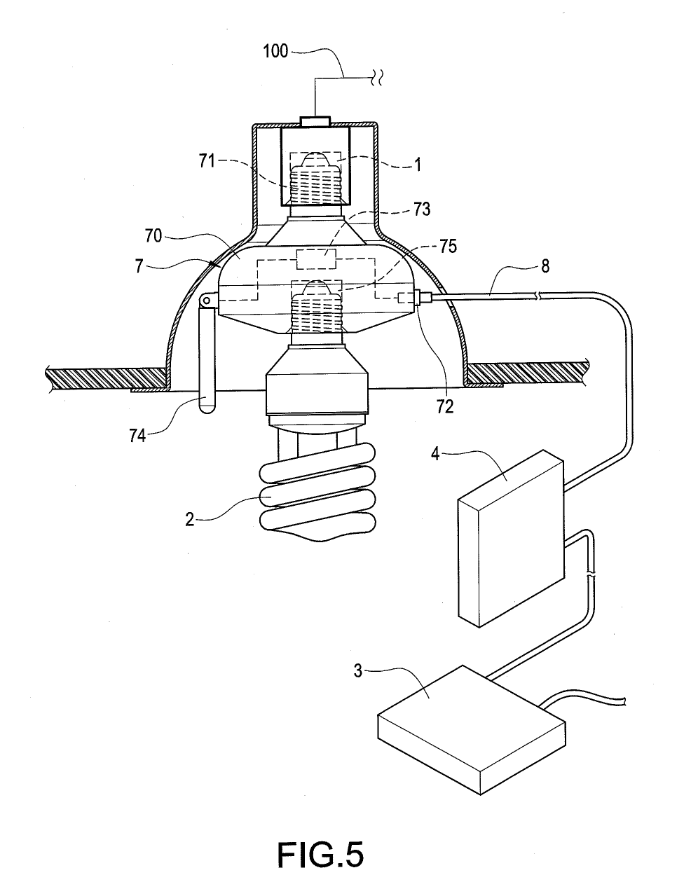

FIG. 5 shows a diagram of another embodiment of the electric lamp holder module after being embedded in the electric lamp slot. In FIG. 5, the signal receiving unit 72 is a cable connector for connecting a cable 8. The signal receiving unit 72 receives the transmission signal S1 through the cable 8. Please refer to FIG. 2 as well. The wireless access point 4 further includes an antenna connector (not shown in FIGS. 2 and 5) for connecting to the antenna 41. Firstly, the antenna 41 is removed from the wireless access point 4. Then, the antenna connector is electrically connected to the signal receiving unit 72 through the cable 8. Therefore, the transmission signal S1 is sent from the wireless access point 4 to the electric lamp holder module 7 through the cable 8. As mentioned above, the operational amplifier 73 is configured to amplify the transmission signal S1 as the transmission signal S2. The operational amplifier 73 is configured to send the transmission signal S2 to the output antenna 74. The output antenna 74 is configured to send out the transmission signal S2. In another word, the wireless access point 4 would include the signal repeater which includes the signal receiving unit 72, the operational amplifier 73, and the output antenna 74. The output antenna 74 would be used as an antenna of the wireless access point 4. The transmission signal S2 which has been amplified is sent out directly from the output antenna 74.

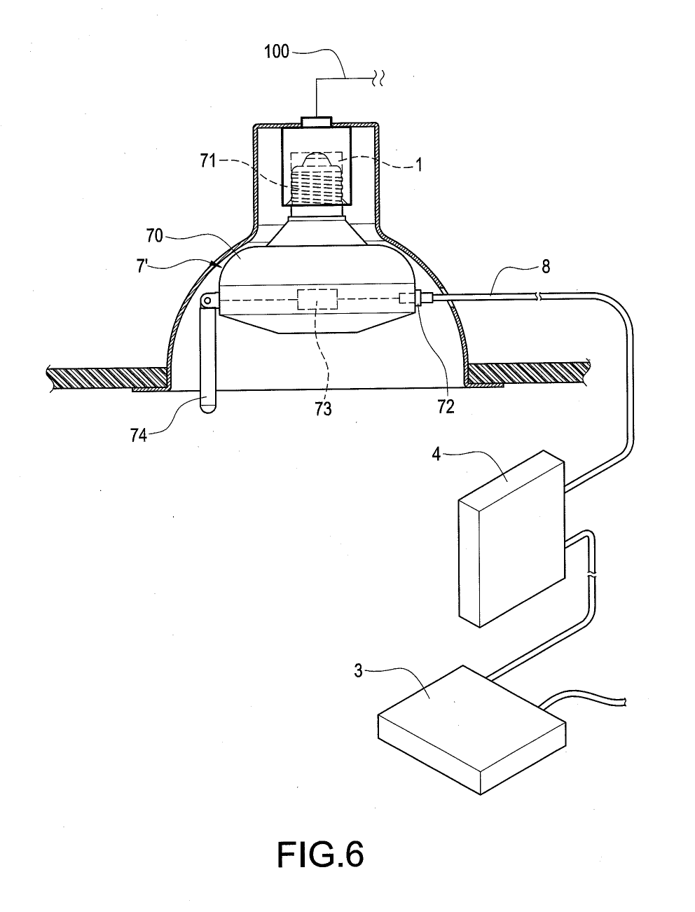

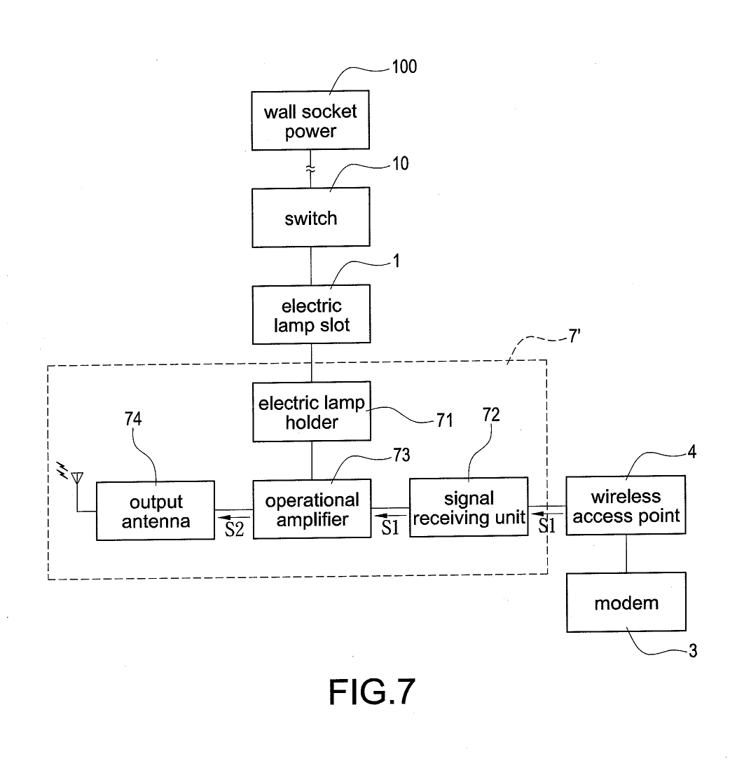

FIG. 6 shows a diagram of another embodiment of the electric lamp holder module after being embedded in the electric lamp slot. FIG. 7 shows a block diagram of another embodiment of the electric lamp holder module of the present invention. The difference between an electric lamp holder module 7′ (as shown in FIGS. 6 and 7) and the electric lamp holder module 7 mentioned above is that the electric lamp holder module 7′ does not include the electric lamp socket 75. Therefore, the electric lamp holder module 7′ is used as a signal repeater only. The electric lamp holder module 7′ is not connected to the electric lamp 2.

Usually, a lot of the electric lamp slots 1 are pre-arranged on the ceilings in a building. However, not every one of the electric lamp slots 1 is connected to the electric lamp 2 for some reasons. For example, one place in the building is bright, so the electric lamp slot 1 in the place is not connected to the electric lamp 2. Or for example, the electric lamp slot 1 is not connected to the electric lamp 2 for saving power. Therefore, the electric lamp slots 1, which are not connected to the electric lamps 2 are wasted. If the electric lamp slots 1, which are not connected to the electric lamps 2 are connected to the electric lamp holder module 7′, the electric lamp slots 1, which are not connected to the electric lamps 2 are not wasted.

The electric lamp holder module 7 and the electric lamp holder module 7′ of the present invention are arranged on proper locations (for example, on the ceilings) and receive the electric power through the electric lamp slots 1 and for being signal repeaters.

Although the present invention has been described with reference to the preferred embodiment thereof, it will be understood that the invention is not limited to the details thereof.

Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electric lamp holder module embedded in an electric lamp slot, the electric lamp holder module including:
an electric lamp holder, the electric lamp holder module embedded in the electric lamp slot through the electric lamp holder and receiving an electric power supplied from a wall socket power;
an operational amplifier electrically connected to the electric lamp holder and receiving the electric power;
a signal receiving unit electrically connected to the operational amplifier and receiving an external transmission signal, the signal receiving unit configured to send the transmission signal to the operational amplifier for amplifying the transmission signal;
an output antenna electrically connected to the operational amplifier and receiving the transmission signal amplified by the operational amplifier, the output antenna configured to wirelessly send out the transmission signal; and
an electric lamp socket electrically connected to the operational amplifier, the electric lamp holder module connected to an electric lamp through the electric lamp socket, the electric lamp receiving the electric power through the electric lamp holder module.

2. The electric lamp holder module in claim 1, wherein the transmission signal is a wireless fidelity signal or a Bluetooth transmission signal.

3. The electric lamp holder module in claim 2, wherein the signal receiving unit is an input antenna for wirelessly receiving the external transmission signal.

4. The electric lamp holder module in claim 2, wherein the signal receiving unit is a cable connector for connecting to a cable; the signal receiving unit receives the external transmission signal.

5. The electric lamp holder module in claim 1, further including:
a housing covering the electric lamp holder, the operational amplifier, the signal receiving unit, and the electric lamp socket,
wherein the output antenna is arranged outside the housing.

6. The electric lamp holder module in claim 5, wherein the output antenna is a directional antenna.

7. An electric lamp holder module embedded in an electric lamp slot, the electric lamp holder module including:
an electric lamp holder, the electric lamp holder module embedded in the electric lamp slot through the electric lamp holder and receiving an electric power supplied from a wall socket power;
an operational amplifier electrically connected to the electric lamp holder and receiving the electric power;
a signal receiving unit electrically connected to the operational amplifier; and
an output antenna electrically connected to the operational amplifier,
wherein a signal repeater includes the operational amplifier, the signal receiving unit, and the output antenna; the signal receiving unit receives an external transmission signal; the signal receiving unit is configured to send the transmission signal to the operational amplifier for amplifying the transmission signal; the output antenna receives the transmission signal amplified by the operational amplifier; the output antenna is configured to wirelessly send out the transmission signal.

8. The electric lamp holder module in claim 7, wherein the transmission signal is a wireless fidelity signal or a Bluetooth transmission signal.

9. The electric lamp holder module in claim 8, wherein the signal receiving unit is an input antenna for wirelessly receiving the external transmission signal.

10. The electric lamp holder module in claim 8, wherein the signal receiving unit is a cable connector for connecting to a cable; the signal receiving unit receives the external transmission signal.
